(19) United States
(12) Patent Application Publication
(10) Pub. No.: US 2014/0221210 A1
(43) Pub. Date: Aug. 7, 2014

(54) ACYL-HOMOSERINE LACTONE DERIVATIVES FOR IMPROVING PLANT YIELD

(71) Applicants: Peter Dahmen, Neuss (DE); Daniela Portz, Vettweiss (DE); Klaus Tietjen, Langenfeld (DE); Jean-Pierre Vors, Sainte-Foy-Les-Lyon (FR)

(72) Inventors: Peter Dahmen, Neuss (DE); Daniela Portz, Vettweiss (DE); Klaus Tietjen, Langenfeld (DE); Jean-Pierre Vors, Sainte-Foy-Les-Lyon (FR)

(21) Appl. No.: 14/343,301

(22) PCT Filed: Sep. 6, 2012
(86) PCT No.: PCT/EP2012/067370

§ 371 Date: Mar. 6, 2014

(30) Foreign Application Priority Data
Sep. 9, 2011 (EP) 11356011.4

(51) Int. Cl. A01N 43/08

(52) U.S. Cl. CPC A01N 43/08
USPC 504/299

(57) ABSTRACT

The present invention relates to methods for improving crop yield, chlorophyll content, seed germination, nutrient uptake or mycorrhizal symbiotic interaction of a plant, comprising the use of acyl-homoserine lactone derivatives and to composition comprising said derivatives of formula (I) or (II) wherein R1 is hydrogen or hydroxyl; R2 is a saturated or mono-unsaturated linear aliphatic group comprising 1 to 15 atoms.

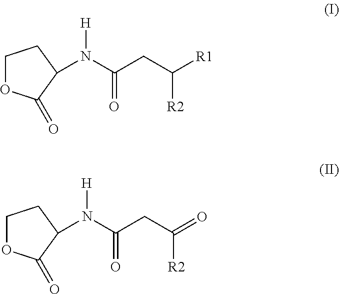

The present invention relates to methods for improving crop yield, chlorophyll content, seed germination, nutrient uptake or mycorrhizal symbiotic interaction of a plant comprising the use of acyl-homoserine lactone derivatives. The present invention also relates to composition comprising said derivatives.

Acyl-homoserine lactones (AHLs) are compounds naturally produced by Gram-negative bacteria. It has been proposed that they could act as signalling molecules: the excreting bacteria might recognize the concentration of said molecules in the environment, and control their growth or other cellular function as production of antibiotics in a population density dependent manner. It has been also reported that the AHL language may also be understood by the plants, allowing them to prepare for a microbial attack or for contact with a symbiotic bacterial artner. Proteome analysis shown that the legume Medicago truncatula responds to the presence of synthetic and purified AHLs from its symbiont Sinorhizobium melilotti with specific and extensive change in root protein expression, and particularly in the expression of potential defense-related proteins, metabolic enzymes, and proteins involved in the recognition of plant hormones auxin and cytokinin (Mathesius U. et al., 2003. P.N.A.S., 100 (3), 1444-1449; Teplitski M. et al; 2011, Chem. Rev., 111, 100-116).

Uta von Rad et al., (Planta, 2008. Vol 229, N) 1, pp 73-85) reports a small increase in Arabidopsis root length in response to N-hexanoyl-d1-homoserine-lactone. Nevertheless said increase is observed only with short chain-AHLs (up to C6-AHLs). No growth promoting effect is observed on leaf tissue or shoot by any of the tested AHLs.

Ortiz-Castro et al. (Plant Cell & Environment, 2008, Vol 31, N^{o} 10, pp 1497-1509) reports no effect on root growth with short chain-AHLs (up to C6-AHLs), and even an inhibitory effect (up to 80% reduction) in root primary length for medium to long chain-AHLs, while root hair formation is promoted. This effect might reinforce the symbiotic behaviours of plant with AHLs-producing-bacterial partners. No effect on yield is reported.

Poonguzhali et al., (Research in Microbiology, 2007, Vol 158, N^{o} 3, pp 287-294) reports that Burkholderia strains stimulates root elongation, and N-acylhomoserine lactone molecules are detected in culture supernatant extract of Burkholderia strains. Nevertheless, no direct relation between these molecules and the root stimulation is shown. No effect on yield is reported.

Huang et al. (Agricultural Science & technology, 2010, 11(1), pp 61-64 reports that AHLs, while inhibiting the growth rate of root and the number of roots, has no effect on plant height, on the number of nodules and leaf size.

It is always of high-interest in agriculture to use novel compounds in order to improve crop yield or plant health. We have now found that acyl-homoserine lactone derivatives can be advantageously and surprisingly used for increasing crop yield. We have also found that acyl-homoserine lactone derivatives improve the symbiotic interaction between plants and fungi, increase the germination of arbuscular mycorrhizal fungi (AMF) spores and increase the nutrient uptake, particularly phosphate and azote, by the plant. Additionally, acyl-homoserine lactone derivatives improve seed germination and greenness (i.e. chlorophyll content) of the plants.

Accordingly, the present invention provides a method for improving a plant, which comprises applying an effective and non-phytotoxic amount of a compound of formula (I) or (II)

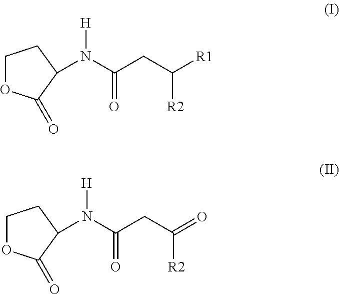

wherein
R1 is hydrogen or hydroxyl;
R2 is a saturated or mono-unsaturated linear aliphatic group comprising 1 to 15 carbon atoms;
   and also the possible geometrical and/or optical isomers, enantiomers and/or diastereoisomers, tautomers, salts, N-oxides, sulfoxides, sulfones, metal or metalloid complexes thereof, which are agriculturally acceptable,
   wherein the compound is applied via seed treatment, foliar application, stem application, drench/drip application (chemigation) to the seed, the plant or to the fruit of the plant or to soil or to inert substrate, Pumice, Pyroclastic materials/tuff, synthetic organic substrates, organic substrates or to a liquid substrate in which the plant is growing or in which it is desired to grow, and
   wherein improving consists of improving crop yield, chlorophyll content, seed germination, nutrient uptake or mycorrhizal symbiotic interaction of said plant.

Any of the compounds used in the invention can exist as one or more stereoisomers depending on the number of stereogenic units (as defined by the IUPAC rules) in the compound. The invention thus relates equally to all the stereoisomers, and to the mixtures of all the possible stereoisomers, in all proportions. The stereoisomers can be separated according to the methods which are known per se by the man ordinary skilled in the art.

The compounds used in the invention can have the R or S configuration relative to the substituent in the 3 position of the lactone (preferentially S) or to the alcohol on the side chain (R1 is hydroxy). The double bond of the side chain can be E or Z, preferentially Z.

According to the invention, the following generic terms are generally used with the following meanings:
halogen means fluorine, chlorine, bromine or iodine;
heteroatom can be nitrogen, oxygen or sulphur;
unless indicated otherwise, a group or a substituent that is substituted according to the invention can be substituted by one or more of the following groups or atoms: a halogen atom, a nitro group, a hydroxy group, a cyano group, an amino group, a sulphenyl group, a pentafluoro-λ⁶-sulphenyl group, a formyl group, a substituted or non-substituted carbaldehyde O—(C₁-C₈-alkyl)oxime, a formyloxy group, a formylamino group, a carbamoyl group, a N-hydroxycarbamoyl group, a formylamino group, a (hydroxyimino)-C₁-C₆-alkyl group, a C₁-C₈-alkyl, a tri(C₁-C₈-alkyl)silyl-C₁-C₈-alkyl, C₁-C₈-cycloalkyl, tri(C₁-C₈-alkyl)silyl-C₁-C₈-cycloalkyl, a C₁-C₈-halogenoalkyl having 1 to 5 halogen atoms, a C₁-C₈-halogenocycloalkyl having 1 to 5 halogen atoms, a C₂-C₈-alkenyl, a C₂-C₈-alkynyl, a C₂-C₈-alkenyloxy, a C₂-C₈-alkynyloxy, a C₁-C₈-alkylamino, a di-C₁-C₈-alkylamino, a C₁-C₈-alkoxy, a C₁-C₈-halogenoalkoxy having 1 to 5 halogen atoms, a C₁-C₈-alkylsulphenyl, a C₁-C₈-halogenoalkylsulphenyl having 1 to 5 halogen atoms, a C₂-C₈-alkenyloxy, a C₂-C₈-halogenoalkenyloxy having 1 to 5 halogen atoms, a C₃-C₈-alkynyloxy, a C₃-C₈-halogenoalkynyloxy having 1 to 5 halogen atoms, a C₁-C₈-alkylcarbonyl, a C₁-C₈-halogenoalkylcarbonyl having 1 to 5 halogen atoms, a C₁-C₈-alkylcarbamoyl, a di-C₁-C₈-alkylcarbamoyl, a N—C₁-C₈-alkyloxycarbamoyl, a C₁-C₈-alkoxycarbamoyl, a N—C₁-C₈-alkyl-C₁-C₈-alkoxycarbamoyl, a C₁-C₈-alkoxycarbonyl, a C₁-C₈-halogenoalkoxycarbonyl having 1 to 5 halogen atoms, a C₁-C₈-alkylcarbonyloxy, a C₁-C₈-halogenoalkylcarbonyloxy having 1 to 5 halogen atoms, a C₁-C₈-alkylcarbonylamino, a C₁-C₈-halogenoalkylcarbonylamino having 1 to 5 halogen atoms, substituted or non-substituted C₁-C₈-alkoxycarbonylamino, substituted or non-substituted C₁-C₈-halogenoalkoxycarbonylamino having 1 to 5 halogen atoms, a C₁-C₈-alkylaminocarbonyloxy, a di-C₁-C₈-alkylaminocarbonyloxy, a C₁-C₈-alkyloxycarbonyloxy, a C₁-C₈-alkylsulphenyl, a C₁-C₈-halogenoalkylsulphenyl having 1 to 5 halogen atoms, a C₁-C₈-alkylsulphinyl, a C₁-C₈-halogenoalkylsulphinyl having 1 to 5 halogen atoms, a C₁-C₈-alkylsulphonyl, a C₁-C₈-halogenoalkylsulphonyl having 1 to 5 halogen atoms, a C₁-C₈-alkylaminosulfamoyl, a di-C₁-C₈-alkylaminosulfamoyl, a (C₁-C₆-alkoxyimino)-C₁-C₆-alkyl, a (C₁-C₆-alkenyloxyimino)-C₁-C₆-alkyl, a (C₁-C₆-alkynyloxyimino)-C₁-C₆-alkyl, (benzyloxyimino)-C₁-C₆-alkyl, C₁-C₈-alkoxyalkyl, C₁-C₈-halogenoalkoxyalkyl having 1 to 5 halogen atoms, benzyloxy, benzylsulphenyl, benzylamino, phenoxy, phenylsulphenyl, or phenylamino;
the term “aryl” means phenyl or naphthyl;

Preferred compounds of formula (I) or (II) according to the invention are those wherein R2 is a saturated linear aliphatic group.

Other preferred compounds of formula (I) or (II) according to the invention are those wherein the mono-unsaturation is located at carbon 5, 7 or 9.

As examples of compounds according to the invention that are particularly advantageous and preferred are compounds wherein R2 is a saturated or mono-unsaturated linear aliphatic group comprising 4 to 15 carbon atoms, more preferably 4 to 10 carbon atoms, even more preferably 4 to 6 carbon atoms. Compounds wherein R2 is a saturated linear aliphatic group comprising 4 to 6 carbon atoms, particularly 5 carbon atoms, is particularly preferred.

As other examples of compounds according to the invention that are particularly advantageous and preferred, mention may be made of the compounds corresponding to one of the following formulae:

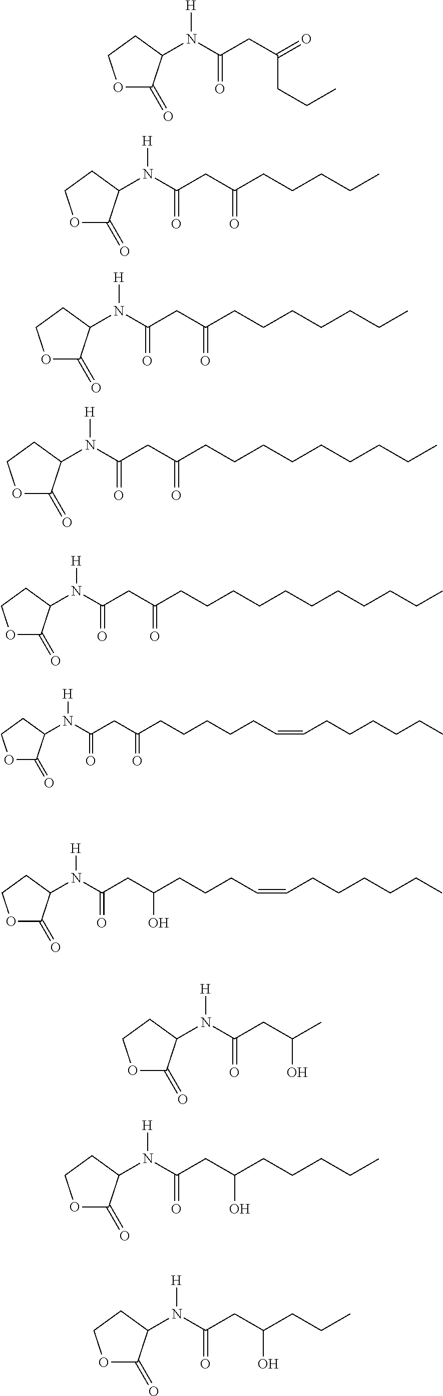

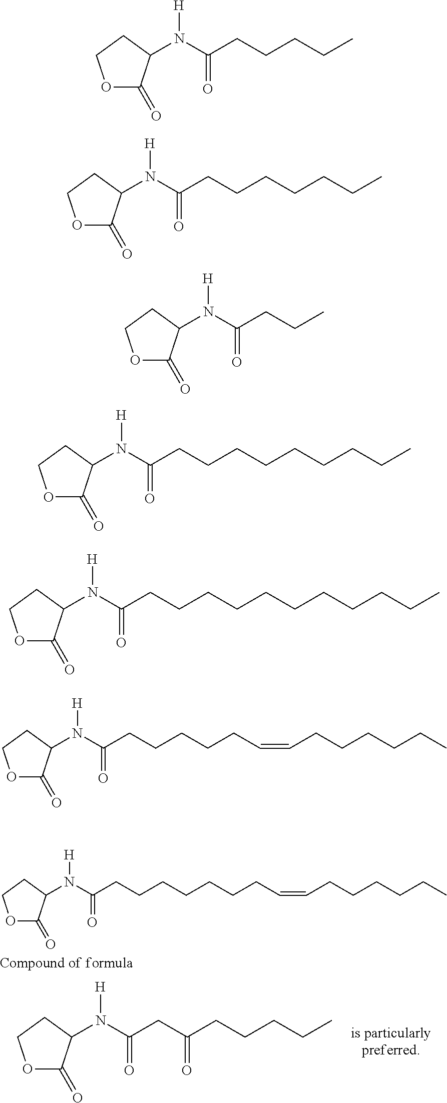

In the context of the invention, crop yield refers not only to the yield of crop per unit area of land under cultivation, but also to the seed generation of the plant itself. Yield can be advantageously measured by the number or weight of grains per plot in tons per ha or by the thousand kernels (TKW).

In the context of the invention, chlorophyll content is an indicator and component of plant health, as chlorophyll generates energy. It can be measured by a SPAD meter reading, such as the SPAD-502 Chlorophyll Meter commercialized by Konica Sensing Inc. Leaf greenness can also be used as an indicator of the chlorophyll content, as green is the color of the chlorophyll. Observation of leaf spectral profile (color) can be made by an optical scanner (Epson ES-2000 optical scanner).

Phosphate and nitrogen are important macronutrients for plants. They are also the most frequently limiting macronutrient for plant growth.

Phosphate is a component of key molecules such as nucleic acids, phospholipids, and ATP and plants cannot growth without a reliable supply of this nutrient. Phosphate is also involved in controlling key enzyme reactions and metabolic pathways.

Although the total amount of phosphate in the soil may be high, it is often present in unavailable forms and the low availability of phosphate in the soil limits plant uptake. Plant mycorrhizae are important for plant phosphate acquisition, since fungal hyphae greatly increase the volume of soil that plant roots explore (D. Schachtman et al., Plant. physiol. (1998) 116:447-453)

In the context of the invention, phosphate uptake relates also to the transport of phosphate from the roots inside the plant.

Nitrogen is an important component of many important structural, genetic and metabolic compounds in plant cells, including chlorophyll, amino acids, ATP, and DNA. Nitrogen is nevertheless not directly available to the plants that need it to growth. Atmospheric nitrogen is thought to be a major source of nitrogen in soils. Some microorganisms can utilize atmospheric N2 to manufacture nitrogenous compounds for use in their own cells. The bacteria Azobacter is able to fix nitrogen, which is released for use by other organisms upon death of the bacteria. But the amount of nitrogen fixed by Agrobacter is relatively weak. Bacteria such as Rhizobia, which infect (nodulate) the roots and stems of plants, particularly legumes, can fix more nitrogen (more than 5 times than Azobacter). When the quantity of nitrogen fixed by Rhizobia exceeds that needed by the microbes themselves it is released for use by the host plant.

The invention also relates to the use of acyl-homoserine lactone derivatives for improving the symbiotic interaction between a plant and arbuscular mycorrhizal (AM) fungi (mycorrhizal symbiosis).

AHLs are compounds naturally produced by Gram-negative bacteria, and it has been proposed that they could act for improving the symbiosis between plants and AHLs-producing-bacteria.

Independently to this rhizobial symbiosis between plant roots and soil bacteria, plant roots can also establish symbiotic relationship with arbuscular mycorrhizal (AM) fungi. These symbiosis are called mycorrhizal symbiosis. Arbuscular mycorrhizae (AMs) are characterized by the formation of unique structures such as arbuscules and vesicles by fungi of the phylum Glomeromycota (AM fungi), for example Glomus sp. or Gigaspora sp. AM fungi (AMF) help plants to capture nutrients such as phosphorus and micronutrients from the soil.

Mycorrization of a plant can be evaluated by the observation of arbuscules and vesicles by microscopy, for example after staining with trypan blue.

In the context of the invention, an increase in AMF spores germination is also a possible component for improving the mycorrhizal symbiosis

Acyl-homoserine lactone derivatives are naturally produced by many Gram-negative bacteria, such as for examples, Sinorhizobium meliloti, Pseudomonas aeruginosa, Pseudomonas putida, Pseudomonas fluorescens, Burkholderia cepacia, Pantoea ananatis and Erwina carotovora. Said naturally compounds may be isolated from the natural organism by standard procedures like solid phase extraction and chromatography as described eg. by Schupp et al. in Anal. Bioanal. Chem. 383: 132-137, 2005) the content of which is incorporated herein by reference), or can be a partial or totally synthetic version of said naturally occurring acyl-homoserine lactones (Hodgkinson et al., Tetrahedron Letters 52: 3291-3294, 2011). Lactone derivatives considered in the present invention may also contain modifications or substitutions which have not been found so far in naturally occurring compounds.

Compounds according to the invention can be prepared according to the above described processes. It will nevertheless be understood that, on the basis of his general knowledge and of available publications, the skilled worker will be able to adapt these processes according to the specifics of each of the compounds according to the invention that is desired to be synthesised.

The present invention relates to the use of an effective and non-phytotoxic amount of an active compound of formula (I) or (II) as herein defined, or of a composition comprising said active compound of formula (I) or (II), particularly for the purpose of improving crop yield, seed germination, nutrient uptake, chlorophyll content or mycorrhizal symbiotic interaction of a plant.

The expression “effective and non-phytotoxic amount” means an amount of compound or composition which is sufficient to improve crop yield, seed germination, nutrient uptake, chlorophyll content or mycorrhizal symbiotic interaction of a plant and which does not entail any appreciable symptom of phytotoxicity for the said plant, crop or seed. Such an amount can vary within a wide range depending on the type of crop, plant or seed, the climatic conditions and the compounds according to the invention. This amount can be determined by systematic field trials, which are within the capabilities of a person skilled in the art.

The invention also relates to a composition comprising, as an active ingredient, an effective amount of a compound of formula (I) or (II) as herein defined and an agriculturally acceptable support, carrier or filler, and to its use for improving crop yield, seed germination, nutrient uptake, chlorophyll content or mycorrhizal symbiotic interaction of a plant.

According to the invention, the term “support” denotes a natural or synthetic organic or inorganic compound with which the active compound of formula (I) or (II) is combined or associated to make it easier to apply, notably to the parts of the plant. This support is thus generally inert and should be agriculturally acceptable. The support can be a solid or a liquid. Examples of suitable supports include clays, natural or synthetic silicates, silica, resins, waxes, solid fertilisers, water, alcohols, in particular butanol organic solvents, mineral and plant oils and derivatives thereof. Mixtures of such supports can also be used.

The composition according to the invention can also comprise additional components. In particular, the composition can further comprise a surfactant. The surfactant can be an emulsifier, a dispersing agent or a wetting agent of ionic or non-ionic type or a mixture of such surfactants. Mention can be made, for example, of polyacrylic acid salts, lignosulphonic acid salts, phenolsulphonic or naphthalenesulphonic acid salts, polycondensates of ethylene oxide with fatty alcohols or with fatty acids or with fatty amines, substituted phenols (in particular alkylphenols or arylphenols), salts of sulphosuccinic acid esters, taurine derivatives (in particular alkyl taurates), phosphoric esters of polyoxyethylated alcohols or phenols, fatty acid esters of polyols and derivatives of the above compounds containing sulphate, sulphonate and phosphate functions. The presence of at least one surfactant is generally essential if the active compound and/or the inert support are water-insoluble and if the vector agent for the application is water. Preferably, surfactant content can be comprised from 5% to 40% by weight of the composition.

Optionally, additional components can also be included, e.g. protective colloids, adhesives, thickeners, thixotropic agents, penetration agents, stabilisers, sequestering agents. More generally, the active compounds can be combined with any solid or liquid additive, which complies with the usual formulation techniques.

Compositions according to the invention can be used in various forms such as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra low volume (ULV) liquid, ultra low volume (ULV) suspension, water dispersible granules or tablets, water dispersible powder for slurry treatment, water soluble granules or tablets, water soluble powder for seed treatment and wettable powder. These compositions include not only compositions which are ready to be applied to the plant or seed to be treated by means of a suitable device, such as a spraying or dusting device, but also concentrated commercial compositions which must be diluted before application to the crop.

The compounds according to the invention can also be mixed with one or more insecticide, fungicide, bactericide, attractant, acaricide, nematicide, molluscicide, pheromone active substance or other compound with biological activity. Said supplementation may be applied simultaneously to the compound of formula (I) or (II) according to the invention, or sequentially.

Advantageously, the compound of formula (I) or (II) according to the invention can be mixed with strigolactone derivatives described in WO2010/125065 the content of which is incorporated herein by reference, with natural lipo-oligosaccharide derivatives (LCOs) such as the one present in commercial product containing LCOs such as OPTIMIZE®, or with synthetic lipo-oligosaccharide derivatives such as the ones described in WO2010/125065 the content of which is incorporated herein by reference.

The compound of formula (I) or (II) according to the invention can also advantageously be mixed with different inoculum sources or biologicals as for example arbuscular mycorrhizal fungi (AMF). Rhizobia, nematicide bacteria such as the Bacillus firmus inoculant Votivo™, or other plant growth promoting bacteria.

AMF could be for example Glomus sp., Gigaspora sp., or other fungi from the group Glomeromycota, while plant growth promoting bacteria others than Rhizobia could be for example Azospirillum sp., Bacillus sp.

The compounds according to the invention can also be mixed with one or more plant growth regulators and plant activators.

Examples of plant growth regulators include, but are not limited to antiauxins (clofibric acid, 2,3,5-tri-iodobenzoic acid), auxins (4-CPA, 2,4-D, 2,4-DB, 2,4-DEP, dichlorprop, fenoprop, IAA. IBA, naphthaleneacetamide, [alpha]-naphthaleneacetic acid, 1-naphthol, naphthoxyacetic acid, potassium naphthenate, sodium naphthenate, 2,4,5-T), cytokinins (2iP, benzyladenine, kinetin, zeatin), defoliants (calcium cyanamide, dimethipin, endothal, ethephon, merphos, metoxuron, pentachlorophenol, thidiazuron, tribufos), ethylene inhibitors (aviglycine, 1-methylcyclopropene), ethylene releasers (ACC, etacelasil, ethephon, glyoxime), gibberellins (gibberellic acid, gibberellins, including non-cyclopropene compounds that show gibberellin-like activity, such as, for example, helminthosporic acid, phaseolic acid, kaurenoic acid, and steviol), growth inhibitors (abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydrojasmon, propham, 2,3,5-tri-iodobenzoic acid), morphactins (chlorfluren, chlorflurenol, dichlorflurenol, flurenol), growth retardants/modifiers (chlormequat, daminozide, flurprimidol, mefluidide, paclobutrazol, cyproconazole, tetcyclacis, uniconazole, a ncymidol, trinexapac-ethyl, and progexadione-CA), growth stimulators (brassinolide, forchlorfenuron, hymexazol, 2-amino-6-oxypurine derivatives, as described below, indolinone derivates, as described below, 3,4-disubstituted maleimide derivatives, as described below, and fused azepinone derivatives, as described below). The term additionally includes other active ingredients such as benzofluor, buminafos, carvone, ciobutide, clofencet, cloxyfonac, cyclanilide, cycloheximide, epocholeone, ethychlozate, ethylene, fenridazon, heptopargil, holosulf, inabenfide, karetazan, lead arsenate, methasulfocarb, prohexadione, pydanon, sintofen, triapenthenol, and trinexapac. Additional plant growth regulators include indolinone derivative plant stimulators described in WO 2005/107466; 3,4-disubstituted maleimide derivatives described in WO 2005/107465; fused azepinone derivatives described in WO 2005/107471; and 2-amino-6-oxypurine derivatives described in WO 2005/107472.

Mixtures with fungicide, insecticide or herbicide compounds are also particularly advantageous.

The invention relates to a method for improving crop yield, seed germination, nutrient uptake, chlorophyll content or mycorrhizal symbiotic interaction of a plant, characterized in that an agronomically effective and substantially non-phytotoxic quantity of a composition comprising a compound of formula (I) or (II) as herein defined is applied as seed treatment, foliar application, stem application, drench or drip application (chemigation) to the seed, the plant or to the fruit of the plant or to soil or to inert substrate (e.g. inorganic substrates like sand, rockwool, glasswool; expanded minerals like perlite, vermiculite, zeolite or expanded clay), Pumice. Pyroclastic materials or stuff, synthetic organic substrates (e.g. polyurethane) organic substrates (e.g. peat, composts, tree waste products like coir, wood fibre or chips, tree bark) or to a liquid substrate (e.g. floating hydroponic systems, Nutrient Film Technique, Aeroponics) wherein the plant is growing or wherein it is desired to grow.

The expression “are applied to the plants to be treated” is understood to mean, for the purposes of the present invention, that the compound of formula (I) or (II) as herein defined or the composition comprising it, can be applied by means of various methods of treatment such as:
spraying onto the aerial parts of the said plants a liquid comprising one of the said compositions,
dusting, the incorporation into the soil of granules or powders, spraying, around the said plants and in the case of trees injection or daubing,
coating or film-coating the seeds of the said plants with the aid of a plant-protection mixture comprising one of the said compositions.

In this method, a composition used can be prepared beforehand by mixing the two or more active compounds according to the invention.

According to an alternative of such a method, it is also possible to apply simultaneously, successively or separately compounds (A) and (B) so as to have the conjugated (A)/(B) effects, of distinct compositions each containing one of the two or three active ingredients (A) or (B).

The dose of active compound of formula (I) or (II) as herein defined usually applied in the method of treatment according to the invention is generally and advantageously
for foliar treatments: from 0.001 mg to 100 g/ha, preferably from 0.01 mg to 50 g/ha, more preferably from 0.05 mg to 10 g/ha;
in case of drench or drip application: from 0.001 mg to 100 g/ha, preferably from 0.01 mg to 50 g/ha, more preferably from 0.05 mg to 10 g/ha. The dose can even be reduced, especially while using inert substrates like rockwool or perlite;
for seed treatment: from 0.001 mg to 100 g/100 kg of seeds, preferably from 0.01 mg to 50 g/100 kg of seeds, more preferably from 0.05 mg to 10 g/100 kg of seeds,;
for soil treatment: from 0.001 mg to 100 g/ha, preferably from 0.01 mg to 50 g/ha, more preferably from 0.05 mg to 10 g/ha.

The doses herein indicated are given as illustrative Examples of method according to the invention. A person skilled in the art will know how to adapt the application doses, notably according to the nature of the plant or crop to be treated.

Under specific conditions, a lower dose can offer adequate protection. Certain climatic conditions or other factors can require higher doses of combined active ingredients. The optimum dose usually depends on several factors, for example on the density of vegetation or alternatively on the method of application.

Without it being limiting, the crop treated with the compound or composition according to the invention is, for example, grapevine, but this could be cereals, vegetables, lucerne, soybean, market garden crops, turf, wood, tree or horticultural plants.

The method of treatment according to the invention can also be useful to treat propagation material such as tubers or rhizomes, but also seeds, seedlings or seedlings pricking out and plants or plants pricking out. This method of treatment can also be useful to treat roots. The method of treatment according to the invention can also be useful to treat the over-ground parts of the plant such as trunks, stems or stalks, leaves, flowers and fruit of the concerned plant.

Among the plants that can be protected by the method according to the invention, mention can be made of cotton; flax; vine; fruit or vegetable crops such as Rosaceae sp. (for instance pip fruit such as apples and pears, but also stone fruit such as apricots, almonds and peaches). Ribesioidae sp., Juglandaceae sp., Betulaceae sp., Anacardiaceae sp., Fagaceae sp., Moraceae sp., Oleaceae sp., Actimidaceae sp., Lauraceae sp., Musaceae sp. (for instance banana trees and plantins). Rubiaceae sp., Theaceae sp., Sterculiceae sp., Rutaceae sp. (for instance lemons oranges and grapefruit); Solanaceae sp. (for instance tomatoes). Liliaceae sp., Asteraceae sp. (for instance lettuces). Umbelliferae sp., Cruciferae sp., Chenopodiaceae sp., Cucurbitaceae sp., Papilionaceae sp. (for instance peas). Rosaceae sp. (for instance strawberries); major crops such as Graminae sp. (for instance maize, lawn or cereals such as wheat, rice, barley and triticale). Asteraceae sp. (for instance sunflower). Cruciferae sp. (for instance colza). Fabacae sp. (for instance peanuts). Papilionaceae sp. (for instance soybean). Solanaceae sp. (for instance potatoes). Chenopodiaceae sp. (for instance beetroots); horticultural and forest crops; as well as genetically modified homologues of these crops.

The composition according to the invention can also be used in the treatment of genetically modified organisms with the compounds according to the invention or the agrochemical compositions according to the invention. Genetically modified plants are plants into genome of which a heterologous gene encoding a protein of interest has been stably integrated. The expression “heterologous gene encoding a protein of interest” essentially means genes which give the transformed plant new agronomic properties or genes for improving the agronomic quality of the modified plant.

The composition according to the invention can also be used against fungal diseases liable to grow on or inside timber. The term “timber” means all types of species of wood and all types of working of this wood intended for construction, for example solid wood, high-density wood, laminated wood and plywood. The method for treating timber according to the invention mainly consists in contacting one or more compounds according to the invention or a composition according to the invention; this includes for example direct application, spraying, dipping, injection or any other suitable means.

The method of treatment according to the invention can be used in the treatment of genetically modified organisms (GMOs), e.g. plants or seeds. Genetically modified plants (or transgenic plants) are plants in which a heterologous gene has been stably integrated into the genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, co suppression technology or RNA interference—RNAi—technology). A heterologous gene that is located in the genome is also called a transgene. A transgene that is defined by its particular location in the plant genome is called a transformation or transgenic event.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the active compounds and compositions which can be used according to the invention, better plant growth, increased tolerance to high or low temperatures, increased tolerance to drought or to water or soil salt content, increased flowering performance, easier harvesting, accelerated maturation, higher harvest yields, bigger fruits, larger plant height, greener leaf color, earlier flowering, higher quality and/or a higher nutritional value of the harvested products, higher sugar concentration within the fruits, better storage stability and/or processability of the harvested products are possible, which exceed the effects which were actually to be expected.

At certain application rates, the active compound combinations according to the invention may also have a strengthening effect in plants. Accordingly, they are also suitable for mobilizing the defense system of the plant against attack by unwanted phytopathogenic fungi and/or microorganisms and/or viruses. This may, if appropriate, be one of the reasons of the enhanced activity of the combinations according to the invention, for example against fungi. Plant-strengthening (resistance-inducing) substances are to be understood as meaning, in the present context, those substances or combinations of substances which are capable of stimulating the defense system of plants in such a way that, when subsequently inoculated with unwanted phytopathogenic fungi and/or microorganisms and/or viruses, the treated plants display a substantial degree of resistance to these unwanted phytopathogenic fungi and/or microorganisms and/or viruses. In the present case, unwanted phytopathogenic fungi and/or microorganisms and/or viruses are to be understood as meaning phytopathogenic fungi, bacteria and viruses. Thus, the substances according to the invention can be employed for protecting plants against attack by the abovementioned pathogens within a certain period of time after the treatment. The period of time within which protection is effected generally extends from 1 to 10 days, preferably 1 to 7 days, after the treatment of the plants with the active compounds.

Plants and plant cultivars which are preferably to be treated according to the invention include all plants which have genetic material which impart particularly advantageous, useful traits to these plants (whether obtained by breeding and/or biotechnological means).

Plants and plant cultivars which are also preferably to be treated according to the invention are resistant against one or more biotic stresses, i.e. said plants show a better defense against animal and microbial pests, such as against nematodes, insects, mites, phytopathogenic fungi, bacteria, viruses and/or viroids.

Plants and plant cultivars which may also be treated according to the invention are those plants which are resistant to one or more abiotic stresses. Abiotic stress conditions may include, for example, drought, cold temperature exposure, heat exposure, osmotic stress, flooding, increased soil salinity, increased mineral exposure, ozon exposure, high light exposure, limited availability of nitrogen nutrients, limited availability of phosphorus nutrients, shade avoidance.

Plants and plant cultivars which may also be treated according to the invention, are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants that may be treated according to the invention are hybrid plants that already express the characteristic of heterosis or hybrid vigor which results in generally higher yield, vigor, health and resistance towards biotic and abiotic stress factors. Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in corn) be produced by detasseling, i.e. the mechanical removal of the male reproductive organs (or males flowers) but, more typically, male sterility is the result of genetic determinants in the plant genome. In that case, and especially when seed is the desired product to be harvested from the hybrid plants it is typically useful to ensure that male fertility in the hybrid plants is fully restored. This can be accomplished by ensuring that the male parents have appropriate fertility restorer genes which are capable of restoring the male fertility in hybrid plants that contain the genetic determinants responsible for male-sterility. Genetic determinants for male sterility may be located in the cytoplasm. Examples of cytoplasmic male sterility (CMS) were for instance described in Brassica species (WO 1992/005251, WO 1995/009910, WO 1998/27806, WO 2005/002324, WO 2006/021972 and U.S. Pat. No. 6,229,072). However, genetic determinants for male sterility can also be located in the nuclear genome. Male sterile plants can also be obtained by plant biotechnology methods such as genetic engineering. A particularly useful means of obtaining male-sterile plants is described in WO 1989/10396 in which, for example, a ribonuclease such as barnase is selectively expressed in the tapetum cells in the stamens. Fertility can then be restored by expression in the tapetum cells of a ribonuclease inhibitor such as barstar (e.g. WO 1991/002069).

Plants or plant cultivars (obtained by plant biotechnology methods such as genetic engineering) which may be treated according to the invention are herbicide-tolerant plants, i.e. plants made tolerant to one or more given herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. Plants can be made tolerant to glyphosate through different means. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., Science (1983), 221, 370-371), the CP4 gene of the bacterium Agrobacterium sp. (Barry et al., Curr. Topics Plant Physiol. (1992), 7, 139-145), the genes encoding a Petunia EPSPS (Shah et al., Science (1986), 233, 478-481), a Tomato EPSPS (Gasser et al., J. Biol. Chem. (1988), 263, 4280-4289), or an Eleusine EPSPS (WO 2001/66704). It can also be a mutated EPSPS as described in for example EP-A 0837944, WO 2000/066746, WO 2000/066747 or WO 2002/026995. Glyphosate-tolerant plants can also be obtained by expressing a gene that encodes a glyphosate oxido-reductase enzyme as described in U.S. Pat. No. 5,776,760 and U.S. Pat. No. 5,463,175. Glyphosate-tolerant plants can also be obtained by expressing a gene that encodes a glyphosate acetyl transferase enzyme as described in for example WO 2002/036782, WO 2003/092360, WO 2005/012515 and WO 2007/024782. Glyphosate-tolerant plants can also be obtained by selecting plants containing naturally-occurring mutations of the above-mentioned genes, as described in for example WO 2001/024615 or WO 2003/013226.

Other herbicide resistant plants are for example plants that are made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition. One such efficient detoxifying enzyme is an enzyme encoding a phosphinothricin acetyltransferase (such as the bar or pat protein from Streptomyces species). Plants expressing an exogenous phosphinothricin acetyltransferase are for example described in U.S. Pat. No. 5,561,236; U.S. Pat. No. 5,648,477; U.S. Pat. No. 5,646,024; U.S. Pat. No. 5,273,894; U.S. Pat. No. 5,637,489; U.S. Pat. No. 5,276,268; U.S. Pat. No. 5,739,082; U.S. Pat. No. 5,908,810 and U.S. Pat. No. 7,112,665.

Further herbicide-tolerant plants are also plants that are made tolerant to the herbicides inhibiting the enzyme hydroxyphenylpyruvatedioxygenase (HPPD). Hydroxyphenylpyruvatedioxygenases are enzymes that catalyze the reaction in which para-hydroxyphenylpyruvate (HPP) is transformed into homogentisate. Plants tolerant to HPPD-inhibitors can be transformed with a gene encoding a naturally-occurring resistant HPPD enzyme, or a gene encoding a mutated HPPD enzyme as described in WO 1996/038567, WO 1999/024585 and WO 1999/024586. Tolerance to HPPD-inhibitors can also be obtained by transforming plants with genes encoding certain enzymes enabling the formation of homogentisate despite the inhibition of the native HPPD enzyme by the HPPD-inhibitor. Such plants and genes are described in WO 1999/034008 and WO 2002/36787. Tolerance of plants to HPPD inhibitors can also be improved by transforming plants with a gene encoding an enzyme prephenate dehydrogenase in addition to a gene encoding an HPPD-tolerant enzyme, as described in WO 2004/024928.

Still further herbicide resistant plants are plants that are made tolerant to acetolactate synthase (ALS) inhibitors. Known ALS-inhibitors include, for example, sulfonylurea, imidazolinone, triazolopyrimidines, pyrimidinyloxy(thio)benzoates, and/or sulfonylaminocarbonyltriazolinone herbicides. Different mutations in the ALS enzyme (also known as acetohydroxyacid synthase, AHAS) are known to confer tolerance to different herbicides and groups of herbicides, as described for example in Tranel and Wright, Weed Science (2002), 50, 700-712, but also, in U.S. Pat. No. 5,605,011, U.S. Pat. No. 5,378,824, U.S. Pat. No. 5,141,870, and U.S. Pat. No. 5,013,659. The production of sulfonylurea-tolerant plants and imidazolinone-tolerant plants is described in U.S. Pat. No. 5,605,011; U.S. Pat. No. 5,013,659; U.S. Pat. No. 5,141,870; U.S. Pat. No. 5,767,361; U.S. Pat. No. 5,731,180; U.S. Pat. No. 5,304,732; U.S. Pat. No. 4,761,373; U.S. Pat. No. 5,331,107; U.S. Pat. No. 5,928,937; and U.S. Pat. No. 5,378,824; and international publication WO 1996/033270. Other imidazolinone-tolerant plants are also described in for example WO 2004/040012, WO 2004/106529, WO 2005/020673, WO 2005/093093, WO 2006/007373, WO 2006/015376, WO 2006/024351, and WO 2006/060634. Further sulfonylurea- and imidazolinone-tolerant plants are also described in for example WO 2007/024782.

Other plants tolerant to imidazolinone and/or sulfonylurea can be obtained by induced mutagenesis, selection in cell cultures in the presence of the herbicide or mutation breeding as described for example for soybeans in U.S. Pat. No. 5,084,082, for rice in WO 1997/41218, for sugar beet in U.S. Pat. No. 5,773,702 and WO 1999/057965, for lettuce in U.S. Pat. No. 5,198,599, or for sunflower in WO 2001/065922.

Plants or plant cultivars (obtained by plant biotechnology methods such as genetic engineering) which may also be treated according to the invention are insect-resistant transgenic plants, i.e. plants made resistant to attack by certain target insects. Such plants can be obtained by genetic transformation, or by selection of plants containing a mutation imparting such insect resistance.

An “insect-resistant transgenic plant”, as used herein, includes any plant containing at least one transgene comprising a coding sequence encoding:
1) an insecticidal crystal protein from Bacillus thuringiensis or an insecticidal portion thereof, such as the insecticidal crystal proteins listed by Crickmore et al., Microbiology and Molecular Biology Reviews (1998), 62, 807-813, updated by Crickmore et al. (2005) at the Bacillus thuringiensis toxin nomenclature, online at: http://www.lifesci.sussex.ac.uk/Home/Neil_Crickmore/Bt/), or insecticidal portions thereof, e.g., proteins of the Cry protein classes Cry1Ab, Cry1Ac, Cry1F, Cry2Ab, Cry3Aa, or Cry3Bb or insecticidal portions thereof; or
2) a crystal protein from Bacillus thuringiensis or a portion thereof which is insecticidal in the presence of a second other crystal protein from Bacillus thuringiensis or a portion thereof, such as the binary toxin made up of the Cry34 and Cry35 crystal proteins (Moellenbeck et al., Nat. Biotechnol. (2001), 19, 668-72; Schnepf et al., Applied Environm. Microbiol. (2006), 71, 1765-1774); or
3) a hybrid insecticidal protein comprising parts of different insecticidal crystal proteins from Bacillus thuringiensis, such as a hybrid of the proteins of 1) above or a hybrid of the proteins of 2) above, e.g., the Cry1A.105 protein produced by corn event MON98034 (WO 2007/027777); or
4) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation, such as the Cry3Bb1 protein in corn events MON863 or MON88017, or the Cry3A protein in corn event MIR604;
5) an insecticidal secreted protein from Bacillus thuringiensis or Bacillus cereus, or an insecticidal portion thereof, such as the vegetative insecticidal (VIP) proteins listed at: http://www.lifesci.sussex.ac.uk/home/Neil_Crickmore/Bt/vip.html, e.g., proteins from the VIP3Aa protein class; or
6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 1994/21795); or
7) a hybrid insecticidal protein comprising parts from different secreted proteins from Bacillus thuringiensis or Bacillus cereus, such as a hybrid of the proteins in 1) above or a hybrid of the proteins in 2) above; or
8) a protein of any one of 1) to 3) above wherein some, particularly 1 to 10, amino acids have been replaced by another amino acid to obtain a higher insecticidal activity to a target insect species, and/or to expand the range of target insect species affected, and/or because of changes introduced into the encoding DNA during cloning or transformation (while still encoding an insecticidal protein), such as the VIP3Aa protein in cotton event COT102.

Of course, an insect-resistant transgenic plant, as used herein, also includes any plant comprising a combination of genes encoding the proteins of any one of the above classes 1 to 8. In one embodiment, an insect-resistant plant contains more than one transgene encoding a protein of any one of the above classes 1 to 8, to expand the range of target insect species affected when using different proteins directed at different target insect species, or to delay insect resistance development to the plants by using different proteins insecticidal to the same target insect species but having a different mode of action, such as binding to different receptor binding sites in the insect.

Plants or plant cultivars (obtained by plant biotechnology methods such as genetic engineering) which may also be treated according to the invention are tolerant to abiotic stresses. Such plants can be obtained by genetic transformation, or by selection of plants containing a mutation imparting such stress resistance. Particularly useful stress tolerance plants include:
a. plants which contain a transgene capable of reducing the expression and/or the activity of poly(ADP-ribose)polymerase (PARP) gene in the plant cells or plants as described in WO 2000/004173 or WO2006/045633 or PCT/EP07/004,142.
b. plants which contain a stress tolerance enhancing transgene capable of reducing the expression and/or the activity of the PARG encoding genes of the plants or plants cells, as described e.g. in WO 2004/090140.
c. plants which contain a stress tolerance enhancing transgene coding for a plant-functional enzyme of the nicotinamide adenine dinucleotide salvage synthesis pathway including nicotinamidase, nicotinate phosphoribosyltransferase, nicotinic acid mononucleotide adenyl transferase, nicotinamide adenine dinucleotide synthetase or nicotine amide phosphoribosyltransferase as described e.g. in WO2006/032469 or WO 2006/133827 or PCT/EP07/002,433.

Plants or plant cultivars (obtained by plant biotechnology methods such as genetic engineering) which may also be treated according to the invention show altered quantity, quality and/or storage-stability of the harvested product and/or altered properties of specific ingredients of the harvested product such as:
1) transgenic plants which synthesize a modified starch, which in its physical-chemical characteristics, in particular the amylose content or the amylose/amylopectin ratio, the degree of branching, the average chain length, the side chain distribution, the viscosity behaviour, the gelling strength, the starch grain size and/or the starch grain morphology, is changed in comparison with the synthesised starch in wild type plant cells or plants, so that this is better suited for special applications. Said transgenic plants synthesizing a modified starch are disclosed, for example, in EP 0571427, WO 1995/004826, EP 0719338, WO 1996/15248, WO 1996/19581, WO 1996/27674, WO 1997/11188, WO 1997/26362, WO 1997/32985, WO 1997/42328, WO 1997/44472, WO 1997/45545, WO 1998/27212, WO 1998/40503, WO99/58688, WO 1999/58690, WO 1999/58654, WO 2000/008184, WO 2000/008185, WO 2000/008175, WO 2000/28052, WO 2000/77229, WO 2001/12782, WO 2001/12826, WO 2002/101059, WO 2003/071860, WO 2004/056999, WO 2005/030942, WO 2005/030941, WO 2005/095632, WO 2005/095617, WO 2005/095619, WO 2005/095618, WO 2005/123927, WO 2006/018319, WO 2006/103107, WO 2006/108702, WO 2007/009823, WO 2000/22140, WO 2006/063862, WO 2006/072603, WO 2002/034923, EP 06090134.5, EP 06090228.5, EP 06090227.7, EP 07090007.1, EP 07090009.7, WO 2001/14569, WO 2002/79410, WO 2003/33540, WO 2004/078983, WO 2001/19975, WO 1995/26407, WO 1996/34968, WO 1998/20145, WO 1999/12950, WO 1999/66050, WO 1999/53072, U.S. Pat. No. 6,734,341, WO 2000/11192, WO 1998/22604, WO 1998/32326, WO 2001/98509, WO 2001/98509, WO 2005/002359, U.S. Pat. No. 5,824,790, U.S. Pat. No. 6,013,861, WO 1994/004693, WO 1994/009144, WO 1994/11520, WO 1995/35026, WO 1997/20936.
2) transgenic plants which synthesize non starch carbohydrate polymers or which synthesize non starch carbohydrate polymers with altered properties in comparison to wild type plants without genetic modification. Examples are plants producing polyfructose, especially of the inulin and levan-type, as disclosed in EP 0663956, WO 1996/001904, WO 1996/021023, WO 1998/039460, and WO 1999/024593, plants producing alpha 1,4 glucans as disclosed in WO 1995/031553, US 2002/031826, U.S. Pat. No. 6,284,479, U.S. Pat. No. 5,712,107, WO 1997/047806, WO 1997/047807, WO 1997/047808 and WO 2000/014249, plants producing alpha-1,6 branched alpha-1,4-glucans, as disclosed in WO 2000/73422, plants producing alternan, as disclosed in WO 2000/047727, EP 06077301.7, U.S. Pat. No. 5,908,975 and EP 0728213,
3) transgenic plants which produce hyaluronan, as for example disclosed in WO 2006/032538, WO 2007/039314, WO 2007/039315, WO 2007/039316, JP 2006/304779, and WO 2005/012529.

Plants or plant cultivars (that can be obtained by plant biotechnology methods such as genetic engineering) which may also be treated according to the invention are plants, such as cotton plants, with altered fiber characteristics. Such plants can be obtained by genetic transformation, or by selection of plants contain a mutation imparting such altered fiber characteristics and include:
a) Plants, such as cotton plants, containing an altered form of cellulose synthase genes as described in WO 1998/000549
b) Plants, such as cotton plants, containing an altered form of rsw2 or rsw3 homologous nucleic acids as described in WO2004/053219
c) Plants, such as cotton plants, with increased expression of sucrose phosphate synthase as described in WO 2001/017333
d) Plants, such as cotton plants, with increased expression of sucrose synthase as described in WO02/45485
e) Plants, such as cotton plants, wherein the timing of the plasmodesmatal gating at the basis of the fiber cell is altered, e.g. through downregulation of fiberselective β 1,3-glucanase as described in WO2005/017157
f) Plants, such as cotton plants, having fibers with altered reactivity, e.g. through the expression of N-acteylglucosaminetransferase gene including nodC and chitinsynthase genes as described in WO2006/136351

Plants or plant cultivars (that can be obtained by plant biotechnology methods such as genetic engineering) which may also be treated according to the invention are plants, such as oilseed rape or related Brassica plants, with altered oil profile characteristics. Such plants can be obtained by genetic transformation or by selection of plants contain a mutation imparting such altered oil characteristics and include:
a) Plants, such as oilseed rape plants, producing oil having a high oleic acid content as described e.g. in U.S. Pat. No. 5,969,169, U.S. Pat. No. 5,840,946 or U.S. Pat. No. 6,323,392 or U.S. Pat. No. 6,063,947
b) Plants such as oilseed rape plants, producing oil having a low linolenic acid content as described in U.S. Pat. No. 6,270,828, U.S. Pat. No. 6,169,190 or U.S. Pat. No. 5,965,755
c) Plant such as oilseed rape plants, producing oil having a low level of saturated fatty acids as described e.g. in U.S. Pat. No. 5,434,283

Particularly useful transgenic plants which may be treated according to the invention are plants which comprise one or more genes which encode one or more toxins, such as the following which are sold under the trade names YIELD GARD® (for example maize, cotton, soya beans), KnockOut® (for example maize), BiteGard® (for example maize), Bt-Xtra® (for example maize), StarLink® (for example maize), Bollgard® (cotton), Nucotn® (cotton), Nucotn 33B® (cotton), NatureGard® (for example maize). Protecta® and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize).

Particularly useful transgenic plants which may be treated according to the invention are plants containing transformation events, or combination of transformation events, that are listed for example in the databases from various national or regional regulatory agencies (see for example http://gmoinfo.jrc.it/gmp_browse.aspx and http://www.agbios.com/dbase.php).

The following examples illustrate in a non-limiting manner the preparation and efficacy of the compounds of formula (I) or (II) according to the invention.

### 1. Arbuscular Mycorrhizal Fungi (AMF) Spore Germination Experiment

Test is performed under lab conditions. The active ingredient was solved in a solvent (acetone) and added to warm culture medium (M-medium; Bécard et Fortin, 1988) to obtain a final concentration of 10⁻⁸M. After filling the culture medium in 24-well plates, AMF spores were deposited on the surface of culture medium. Plates were incubated at 26.5° C. in the dark. Assessment consisted of counting of germinated spores 3 and 4 days after application (daa).

Compound A1

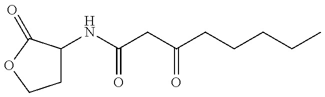 [SMILES: CCCCCC(=O)CC(=O)NC1CCOC1=O]

| | Germination | Germination |
|---|---|---|
| | rate 3 daa | rate 4 daa |
| | [%] | [%] |
| Control | 54 | 65 |
| A1 | 58 | 78 |

average of 3 replicates

Application of compound A1 on spores of arbuscular mycorrhizal fungi demonstrates a significative increase of the germination rate, comparatively to control.

### 2. In Vitro Phosphate Transport to Host Plant by Mycorrhizal Fungi

One-week-old Medicago truncatula plantlets were transferred in the AM-P in vitro culture systems (details on AM-P systems see: H. Dupré Boulois et al., 2006). The roots were placed in the root compartment (RC) on the surface of the solid MSR medium (Declerck et al., 2003) lacking vitamins and sucrose. The RC was filled with 25 ml and the hyphal compartment (HC) with 20 ml of solid MSR medium, lacking sucrose, vitamins and solidified with 3 g l⁻¹ Phytagel.

Roots of M. truncatula plantlets were subsequently inoculated with the spores (±100) of Glomus intraradices. The bi-compartmented Petri plates of the AM-P in vitro culture systems were then sealed using Parafilm (Pechiney, Menasha, Wis., USA) and wrapped in black plastic bags to maintain roots and the G. intraradices in the dark. The AM-P in vitro culture systems were subsequently incubated in a controlled environment chamber (20° C., 16 h photoperiod). The AMP in vitro culture systems were supplied weekly with 5 ml of MSR medium up to 2 weeks before radio-isotopic labelling (10 weeks after inoculation).

Three weeks after inoculation, AM fungal mycelium started to contact the roots and to develop in the entire volume of the RCs. Between week 5 and 7, the mycelium crossed the partition wall between the RCs and HCs and started to develop in the HCs. The roots that crossed the plastic barrier were trimmed to leave the HC void of roots. Eight weeks after inoculation, the medium contained in the HCs was removed and then replaced by fresh MSR medium, lacking sucrose, vitamins and solidified with 3 g l⁻¹ Phytagel. In this medium, the active ingredient at the desired concentrations (in 0.1% acetone) was also added. The mycelium started immediately to re-grow into the fresh medium containing the active ingredient. At time of labeling, the mycelium in the HCs was 2 weeks-old.

### Radio-Isotopic Labeling

Ten weeks after beginning of the experiment (i.e. 2 weeks after initiation of hyphal development in the HCs containing the active ingredient), filter-sterilized (Acrodisc® Syringe Filters, PALL Corporation, Ann Arbor, Mich., USA) phosphorus (³³P) was added in the HCs (489520+/−12080 CPM per systems). The source of ³³P was orthophosphate in dilute hydrochloric acid (<0.1 M) supplied by Amersham Pharmacia Biotech (Buckinghamshire, UK). A control treatment was included. Four replicates were considered per treatment.

### Harvest and Plant—Arbuscular Mycorrhiza Fungal Analyses

At the end of the experiment (i.e. 96 hours after the addition of ³³P), the shoots of M. truncatula were collected by cutting the shoots at the level of the solidified MSR medium contained in the RCs. The roots were then removed from the solidified MSR medium and cleaned-free from the remaining gel and extraradical mycelium. Root and shoots were oven dried (60° until constant weight) and weighted. Afterwards roots and shoots were crushed in mortar using liquid nitrogen and dried again (60° until constant weight). Fifty milligrams of each sample was taken and placed in a 15 ml glass tube. One milliliter of nitric acid (68%) was thereafter added into the tubes. One day later, the tubes were placed on a heater block at 140° C. for 2 h and then at 180° C. for 10 min. After cooling, the volume of the tube was adjusted at 10 ml with distilled water. From this, 3 ml were taken up and placed in a 20 ml scintillation tube (Perkin Elmer N.V./S.A., Zaventem, Belgium). In each tube, 15 ml of liquid scintillation cocktail having a high resistance to color and chemical quench (Ultima Gold AB™, Packard BioScience, Groningen, the Netherlands) was added. Samples were then subjected to ³³P counting on a Packard TR2500 Liquid Scintillation Analyser (Packard Instrument, Meriden, Conn., USA).

| | ³³P counting | ³³P counting |
|---|---|---|
| | shoot | root |
| Control | 13750.7 | 76630.9 |
| A1 (10⁻⁶ M) | 61277.6 | 121485.7 |
| A1 ((10⁻⁷ M)) | 70473.9 | 111374.4 |

average of 4 replicates

Application of compound A1 on arbuscular mycorrhizal fungi demonstrates a significant increase of ³³P transport from culture medium to host plants by the fungi, comparatively to control.

### 3. Germination Test on Maize, Soybean and Wheat

The test is performed under lab conditions.

Soybean and maize seeds, treated with the active ingredient solved in DMSO and diluted with water to the desired dosages, are placed on sterile agar plates (0.5% agar in water). Covered plates are incubated at 7.5° C. and 10° C. respectively in the dark. Wheat seeds, treated with the active ingredient, solved in DMSO and diluted with water to the desired dosages, are placed on sterile agar plates (1% agar in water). Covered plates are incubated at 7.5° C. in the dark.

Controls are performed in the same conditions in the absence of the active ingredient. Assessment consisted of counting germinated seeds per plate at different time points.

Soybean

| | Germination |
|---|---|
| | rate 7 daa [%] |
| Control | 65 |
| A1 (0.1 mg/ha) | 77 |
| A1 (1 mg/ha) | 84 |

Maize

| | Germination |
|---|---|
| | rate 6 daa [%] |
| Control | 85 |
| A1 (0.1 mg/ha) | 95 |
| A1 (1 mg/ha) | 94 |

Wheat

| | Germination |
|---|---|
| | rate 3 daa [%] |
| Control | 41 |
| A1 (0.1 mg/ha) | 52 |
| A1 (1 mg/ha) | 69 |

average of 5 replicates of 20 seeds

Application of compound A1 on soybean, maize and wheat seeds demonstrates a significative increase of the germination rate, comparatively to control.

### 4. Greenhouse Experiments on Maize Under Low Phosphate Conditions

Test is performed in the greenhouse. 5 maize seeds per treatment were sown in 500 ml rose pots (7×7×18 cm) containing a mix of sand and perlite (1:1). 3 replicates were made. The active ingredient was solved in a DMSO and seed treatment was performed with lab equipment.

To inoculate with arbuscular mycorrhizal fungi, 8 ml inoculum (AMykor GmbH; Germany) were mixed with 1 l of the sand-perlite mixture.

Seeds were covered by 3 cm of LECA (light expanded clay aggregate). Pots were incubated in the greenhouse for 6 weeks at 21.5° C./14° C. (day/night) and 80% relative humidity. Once a week plants were watered with nutrient solution (half concentrated Hoagland solution (Hoagland and Arnon, 1950)) containing only a low concentration of phosphate (20 μM).

Assessment consisted of mycorrhization of roots. Mycorrhization was evaluated after trypan blue staining by microscopy.

Controls are performed in the same conditions in the absence of the active ingredient.

| | Mycorrhization |
|---|---|
| | [%] |
| Control | 2.5 |
| A1 (0.1 mg/ha) | 4.3 |

average of 3 replicates of 5 plants

Application of compounds A1 on maize seeds demonstrates a significative higher colonization by symbionts (mycorrhiza), comparatively to the control.

### 5. Greenhouse Experiments on Maize

Test is performed under greenhouse conditions. Plants were grown in pots on a growth bench in the greenhouse at constant air temperature of 25° C. (day) and 20° C. (night) and 65% relative humidity.

Plants were regularly watered with ½ strength Hoagland's solution containing nitrogen (Hoagland and Arnon, 1950) as needed.

Maize seeds were carefully surface sterilized in 2% sodium hypochlorite for 3 min. followed by several rinsing with sterile distilled water (Bhuvaneswari et al. 1980). Seeds were directly sown in pots (190 cm diameter) containing a mixture of sand and turface (2:1, v/v) (2.5 L in each pot. Five seeds were put in each pot. The seeds were covered gently with the potting mixture and kept on the growth bench. After counting emergence, seedlings were thinned to one seedling per pot.

Before sowing, seeds were soaked in solution containing the active ingredient at the desired concentration for at least two hours.

The plants were allowed to grow for 45 days after seeding and were then harvested for final data collection. Data were collected on the SPAD meter readings (leaf greenness measurements (chlorophyll content); SPAD-502 Chlorophyll Meter (Konica Minolta Sensing Inc., Japan)

| | SPAD |
|---|---|
| Control | 40 |
| A1 (0.1 mg/ha) | 42 |

average of 4 replicates

Application of compounds A1 on maize seeds demonstrates higher chlorophyll concentration (SPAD measurement), comparatively to the control.

### 6. Greenhouse Experiments on Soybean

Test is performed under greenhouse conditions. The experiment was conducted at a constant air temperature of 25° C. (day) and 20° C. (night) and 65% relative humidity. Plants were regularly watered with ½ strength Nitrogen free Hoagland's solution (Hoagland and Arnon, 1950) as needed.

### Bacterial Growth and Incubation:

Initial culture of Bradyrhizobium japonicum was prepared by inoculating single cell colonies from petri plates in 200 mL Yeast Extract Mannithol (YEM) broth (pH 6.8) and incubated at 28° C. and shaken at 150 rpm until an OD₆₀₀ of 0.2-0.3 is achieved (2-3 days). Absorbance (A600 nm) of the bacterial cultures was determined using a spectrophotometer. The culture was diluted to an OD₆₀₀ of 0.08 and 1 mL of this culture was used for inoculation onto seeds of all treatments.

### Plant Material:

Soybean seeds were surface sterilized in 2% sodium hypochlorite for 3 min and then rinsed several times with distilled water (Bhuvaneswari et al. 1980). Seeds were directly sown in pots (130 mm diameter) containing a mixture of sand and turface (2:1, v/v). Five soybean seeds were put in each. Before sowing seeds were soaked in solution containing the active ingredient at the desired concentration for at least two hours. Bradyrhizobium japonicum inoculant prepared as described above was inoculated onto soybean seeds by pipetting 1 mL of diluted culture onto each seed. The seeds were covered gently with the potting mixture, kept on the growth bench. After monitoring emergence, seedlings were thinned to one seedling per pot.

The plants were allowed to grow for 45 days after seeding and were then harvested for final data collection. Data were collected on the following variables:
1. SPAD meter readings (leaf greenness measurements (chlorophyll content); SPAD-502 Chlorophyll Meter (Konica Minolta Sensing Inc., Japan)
2. Number of nodules per plant
3. Nodule dry weight

| | Number of | Nodule | |
|---|---|---|---|
| | nodules | weight (dry)[g] | SPAD |
| Control | 76 | 0.168 | 28 |
| A1 (0.1 mg/ha) | 84 | 0.180 | 34 |

average of 4 replicates

Application of compounds A1 on soybean seeds demonstrates an increase of biomass (root and shoot) and chlorophyll concentration potentially resulting in a higher photosynthetic activity. In addition Application of compounds A1 on soybean seeds leads to a significative higher colonization by symbionts (Rhizobia, nodulation), comparatively to the control.

### 7. Maize and Wheat Field Trials (2010)

Maize and wheat field trials were conducted in order to evaluate several assessments including the weight of plant (leaf+roots), the formation of mycorrhiza, and yield parameters like the weight of grains per plot in tons per ha and the 1000 kernel weight. In addition to the tested compounds, a basic treatment of fungicides was also applied on the seeds.

The tested active ingredients were pre-diluted in DMSO and applied on seeds in tank mix with fungicides.

Description of trial conditions and results are given below.

Maize: Germany (Voiswinkel), soil description: sandy loam, phosphor 11 mg/100 g soil, potassium 7 mg/100 g soil, magnesium 9 mg/100 g soil, organic matter 1.3%, pH 6.0. Sowing date: 2010-05-21

Spring wheat: Germany (Monheim), soil description: sandy loam, phosphor 11 mg/100 g soil, potassium 14 mg/100 g soil, magnesium 8 mg/100 g soil, organic matter 1.2%, pH 6.4. Sowing date: 2010-04-01

In both crops no phosphate or potassium fertilizer were applied.

### Dosages Maize:

Compound A1: 0.1 and 1 milligrams active ingredient per hectare

Base: Fungicide: Prothioconazole+Metalaxyl FS 120/Dosage: 12 grams active ingredient per 100 kg seeds

### Dosages Wheat:

Compound A1: 0.1 and 1 milligrams active ingredient per hectare

Base: Fungicide: Fluoxastrobin+Prothioconazole+Tebuconazole FS 80/Dosage: 5.6+5.6+0.747 grams active ingredient per 100 kg seeds.

The following yield parameters were assessed: tons per hectare (for wheat only), TKW=1000 kernel weight. Mycorrhization of roots of spring wheat plants was assessed by trypan blue staining followed by microscopy.

### Results:

Maize

| | TKW [g] |
|---|---|
| Base | 192.4 |
| Base + compound A1 | 197.8 |
| (0.1 mg/ha) | |
| Base + compound A1 | 200.6 |
| (1 mg/ha) | |

Spring wheat

| | TKW [g] | Mycorrhization [%] |
|---|---|---|
| Base | 30.3 | 1.7 |
| Base + compound A1 | 32.4 | 4.2 |
| (0.1 mg/ha) | | |
| Base + compound A1 | 32.1 | 2.0 |
| (1 mg/ha) | | |

average of 4 replicates

Application of compound A1 on maize seeds lead to higher thousand kernel weight. Seed treatment of spring wheat with compound A1 demonstrates a stimulation of mycorrhization and lead to a significative yield increase.

1. A method for improving a plant which comprises applying an effective and non-phytotoxic amount of a compound of formula (I) or (II) 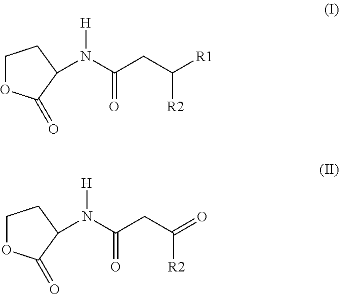
wherein
R1 is hydrogen or hydroxyl;
R2 is a saturated or mono-unsaturated linear aliphatic group comprising 1 to 15 carbon atoms;
and also the possible geometrical and/or optical isomers, enantiomers and/or diastereoisomers, tautomers, salts, N-oxides, sulfoxides, sulfones, metal or metalloid complexes thereof, which are agriculturally acceptable,
wherein said compound is applied via seed treatment, foliar application, stem application, drench/drip application (chemigation) to the seed, the plant or to the fruit of the plant or to soil or to inert substrate, Pumice, Pyroclastic materials/tuff, synthetic organic substrates, organic substrates or to a liquid substrate in which the plant is growing or in which it is desired to grow,
and wherein improving consists of improving crop yield, chlorophyll content, seed germination, nutrient uptake or mycorrhizal symbiotic interaction of said plant.

2. A method according to claim 1 wherein the mono-unsaturation is located at carbon 5, 7 or 9.

3. A method according to claim 1 wherein the compounds of formula (I) or (II) is selected from the list consisting of:

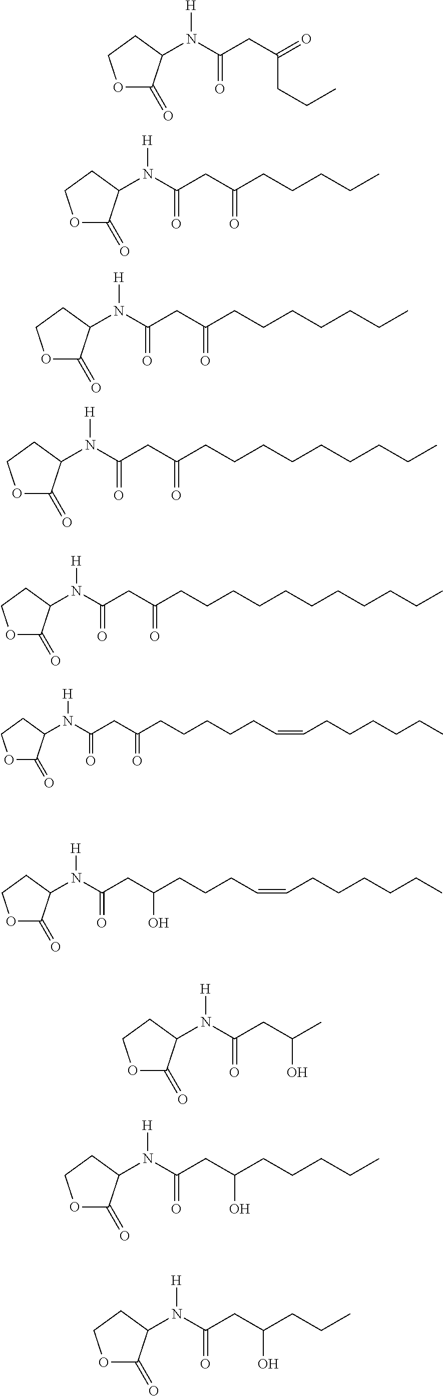

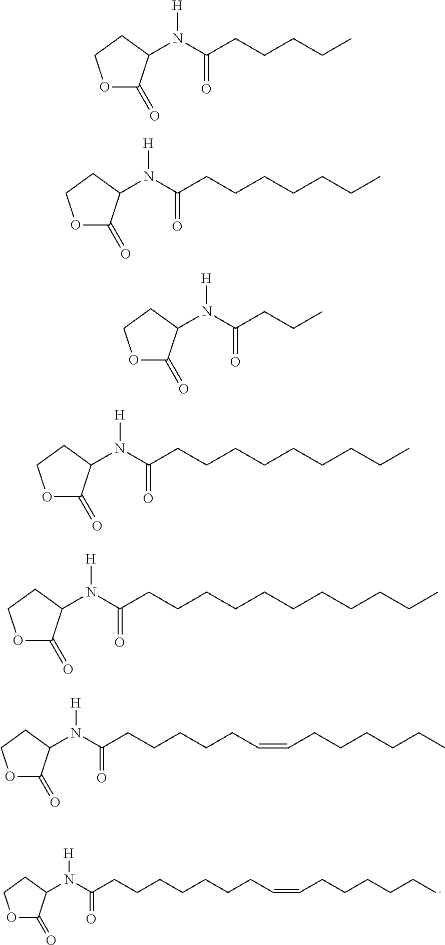

4. A method according to claim 1 wherein a further biological or pesticidal active ingredient is applied to the seed, the plant, the fruit of the plant or to soil or to substrate in which the plant is growing or in which it is desired to grow, simultaneously to the compound of formula (I) or (II) or sequentially.

5. A method according to claim 4 wherein the further biological or pesticidal active ingredient is a insecticide, fungicide, bactericide, attractant, acaricide, nematicide, molluscicide, pheromone, mycorrhiza or rhizobia inoculant, plant growth promoting bacteria, nematicide bacteria, plant growth regulator or plant activator.

6. A method according to claim 1, characterized in that the compound of formula (I) or (II) is applied in furrow on the soil.

7. A method according to claim 1, characterized in that the compound of formula (I) or (II) is applied in seed treatment.

8. The use of a compound of formula (I) or (II) 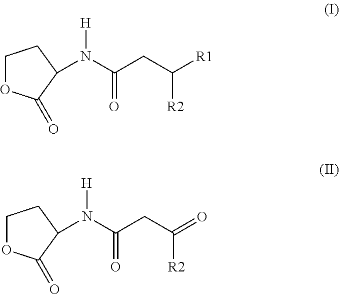
wherein
R1 is hydrogen or hydroxyl;
R2 is a saturated or mono-unsaturated linear aliphatic group comprising 1 to 15 carbon atoms;
and also the possible geometrical and/or optical isomers, enantiomers and/or diastereoisomers, tautomers, salts, N-oxides, sulfoxides, sulfones, metal or metalloid complexes thereof, which are agriculturally acceptable, for improving crop yield, chlorophyll content, seed germination, nutrient uptake or mycorrhizal symbiotic interaction of a plant.

9. The use according to claim 8 wherein the mono-unsaturation is located at carbon 5, 7 or 9.

10. The use according to claim 8 wherein the compounds of formula (I) or (II) is selected from the list consisting of: 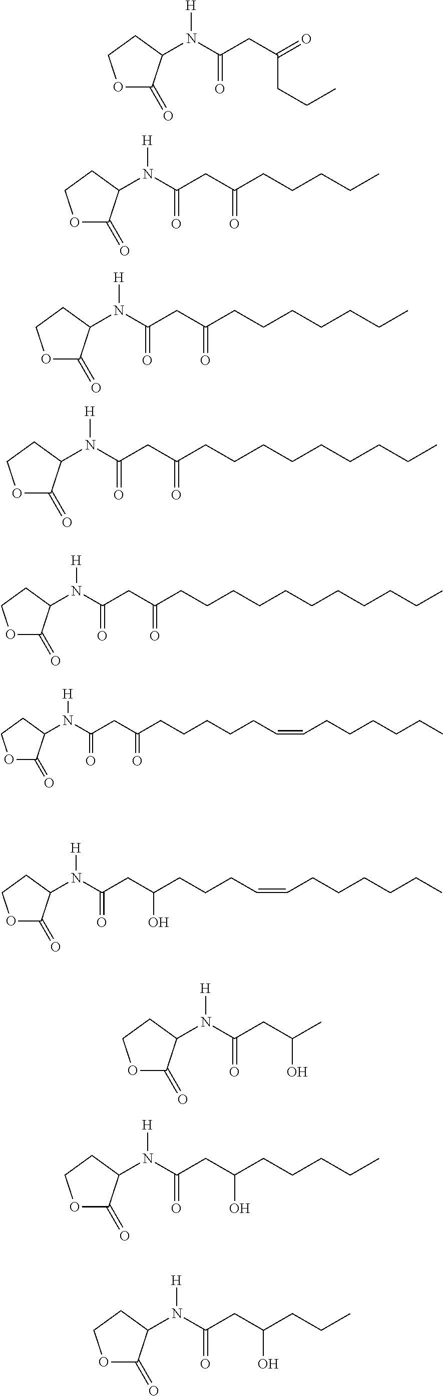 [chemical structure]
